(19) United States
(12) Patent Application Publication
(10) Pub. No.: US 2013/0175250 A1
(43) Pub. Date: Jul. 11, 2013

(54) GROUND-COMPACTING DEVICE

(71) Applicants: Gregory W. Saatkamp, Sheboygan, WI (US); Helena Kathleen Saatkamp, Sheboyban, WI (US); John Whealon, West Bend, WI (US); Michael Peters, West Bend, WI (US)

(72) Inventors: Gregory W. Saatkamp, Sheboygan, WI (US); Helena Kathleen Saatkamp, Sheboyban, WI (US); John Whealon, West Bend, WI (US); Michael Peters, West Bend, WI (US)

(73) Assignee: Goldie Locks LLC, Sheboygan, WI (US)

(21) Appl. No.: 13/809,268

(22) PCT Filed: Jul. 8, 2011
(86) PCT No.: PCT/US2011/043381

§ 371 Date: Mar. 25, 2013

Related U.S. Application Data
(60) Provisional application No. 61/362,779, filed on Jul. 9, 2010.

(51) Int. Cl. A47J 36/24

(52) U.S. Cl. CPC A47J 36/2483
USPC 219/387

(57) ABSTRACT

A food and beverage warming device according to the invention includes a housing having a container received in a cavity defined by the housing. The container is sized, shaped, and configured to receive a can of food or beverage. The food and beverage warming device is selectively operably coupleable to an external power source such as a cigarette light adapter of vehicle or the like. When connected to the power source, a heating element mounted to the container is energized to warm the container. The can contained in the container, and the food held therein, is warmed via heat transfer from the heating element. A thermostat is provided and operably interconnected with the power source and the heating element. The thermostat is configured to monitor and regulate the temperature of the container and by virtue the can contained therein.

### CROSS-REFERENCE TO RELATED APPLICATIONS

The present application claims the benefit of priority to U.S. Provisional Patent Application Ser. No. 61/362,779 filed on Jul. 9, 2010 and titled Can Warmer, the entirety of which is hereby expressly incorporated by reference thereto.

### BACKGROUND OF THE INVENTION

1. Field of the Invention

The present invention is directed to a food warmer and, in particular, a portable device for warming food in its original container.

2. Discussion of the Related Art

There has long been a need for warming a consumable item, e.g., food and beverages, quickly and easily. For instance, travelers on road trips have often desired eating or drinking warm food and drink without having to stop and prolong the length of their travels. In particular, truck drivers and recreational vehicle operators have often sought to eat and drink on the go.

One such way in which travelers have accomplished the eating or drinking of a warm beverage has been to use thermally insulated containers and/or cups. This, of course, requires the user to stop at a location, such as a truck stop, and use a microwave, stove, oven or other heating device to warm the food and/or beverage. These methods suffer from a number of disadvantages. First, these methods require that the user stop along their route to heat their food or beverage. This is not always convenient, as it may be several miles between truck/rest stops. Accordingly, a user may have to heat his or her food and beverage long before or after it is actually desired. Further, it increases the user's travel time in that the user must make a separate stop to warm the food or drink. This method also potentially creates additional waste in the instance where the user uses a disposable container or cup to heat his or her food. Alternatively, if the user uses a reusable container, it requires that the user subsequently clean the reusable container prior to subsequent use. Obviously, this is another time-consuming process as the user must wait until he or she reaches a rest area, such as a truck stop to clean his or her container, oftentimes in a bathroom ill equipped for cleaning such items. It additionally requires that the user carry or provide his or her soap for thoroughly cleaning the container so as to prevent the accumulation of potentially harmful bacteria and the like.

In light of the foregoing, it has been known to utilize in-vehicle heating units. Such heating units commonly utilize either the electrical output of the vehicle's cigarette lighter or piggyback off the heating and cooling system of the vehicle. Such heating units typically include a heating element configured to receive a specialized container within a cavity such that the heating element is held in close contact with the specialized container. Thus, as desired, the user fills the specialized container with his or her desired food or beverage and plugs the unit into the cigarette lighter adapter of the vehicle. These units are typically quite simple in construction and do not comprise on/off switches or thermostats for monitoring and regulating the temperature of the contents of the container. Thus, the user has no way of knowing when the food or beverage has been heated to a satisfactory temperature. As such, the user may be burned by a food or beverage that has been overheated or may consume a food or beverage that has not been thoroughly heated. Finally, the specialized container requires that it be cleaned in between uses, which results in a number of disadvantages already discussed herein.

Thus, it has become desired to provide a device for heating a food or beverage without the foregoing disadvantages. One such way that is commonly employed is the use of a heating box in which a soup container or the like may be simply placed inside the cavity of the box. The box is interconnected with the cigarette lighter adapter, as before, such that a heating element of the box warms the cavity thereof to thereby heat the food or beverage in the container. Again, this device suffers from a number of disadvantages. In particular, known devices do not incorporate a thermostat for monitoring and regulating the temperature of the cavity of the box. Thus, it is possible for the contents of the container to be over or under heated. In the case of overheating, it is possible that the container may explode or even catch fire if allowed to heat too long. This presents a rather serious safety issue especially when used while traveling as the user may become injured by an exploding container thus impairing his or her ability to drive his or her vehicle and thereby expose other drivers on the road to dangerous driving conditions. Finally, in known cigarette adapter devices like the heating box and the specialized container device discussed previously, a great deal of the vehicle's electrical resources is expended. This may lead to a number of disadvantages in performance of the vehicle, and is particularly disadvantageous in cases where the user, such as truck drivers or recreational vehicle drivers, is traveling great distances.

In light of the foregoing, it is desired to provide a device for heating a food or beverage in its original container while additionally being able to regulate the temperature of the contents to ensure thorough but not excessive heating thereof. Additionally, it is desired to provide a device that is relatively simple to use and which requires a minimal amount of cleaning and maintenance. In addition, it is desired to provide a device that creates a minimal amount of additional waste. Further, it is desired to provide a device, which requires a minimal amount of electrical power to operate so as to not adversely affect operation of the vehicle. Finally, it is desired that the device be constructed so as to operate in a safe manner and in accordance with highway safety and other such safety regulations.

### SUMMARY AND OBJECTS OF THE INVENTION

The device of the present invention is a food and beverage warming device that is configured to heat a food or beverage in its original store-bought container, such as soup in its original container or can, using the cigarette adapter of a vehicle. The device is configured to operate at or below 12 Volts, such that operation of the vehicle is not adversely impacted in a meaningful manner. Further, the device includes a heat regulation means, such as a thermostat, that is configured for monitoring and regulating the heating elements of the device to ensure thorough warming of the contents of the can but also preventing overheating thereof.

Thus, in one embodiment of the invention, a food and beverage warming device is provided that includes a housing having a circumferential sidewall, a bottom wall, and an opening opposite the bottom wall in which the sidewalls and bottom wall serve to define a cavity. A container is configured to be securely received within the cavity. The container is generally sized and shaped to receive a can of a food or beverage. A thermostat and a heating element are mounted to an exterior of the container's sidewall. The thermostat and heating element are operably coupled to one another such that the thermostat is capable of selectively energizing or de-energizing the heating element. Thus, the food and beverage warming device is prevented from overheating while ensuring that it reaches a temperature sufficient for consumption of a warmed food or beverage. Further, the food and beverage warming device allows for the food or beverage to be safely heated in its original container such that no additional waste is created.

An indicator light may be provided on an exterior of the food and beverage warming device to indicate the status of the heating element. In particular, the indicator light may be illuminated when the heat element is being energized, i.e., applying heat to the container, and it may be turned off when the heat element is de-energized. Alternatively, the light may be used to indicate when the food has reached the optimal temperature for consumption. One or more additional indicator lights may be provided for carrying out one or more of the foregoing aspects of the invention.

The housing of the food and beverage warming device is preferably constructed from a plastic or other non-conductive material such that it may be easily and safely carried by the user even when the contents have been thoroughly heated. Further, the housing may include a handle for grasping by the user.

A gap may be provided between an inside surface of the housing and an outside surface of the cylindrical container received within the housing. The gap serves as a thermal break between the container and the housing to provide a heat sink.

The container may be constructed from aluminum or another similarly conductive material such that the heating element may easily transfer heat through the walls of the container to the can of food or beverage inside the container.

A lid may be provided over the opening of the housing. The lid serves to trap heat inside the housing to prevent escape through the opening to improve the efficiency thereof Further, it provides a safety mechanism to prevent a user from accidentally contacting the can or container while it is being heated.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

In the Drawings:

FIG. 1 is an isometric view of a food and beverage warming device according to the invention;

FIG. 2 is a front elevation view of the food and beverage warming device of FIG. 1;

FIG. 3 is a rear elevation view of the food and beverage warming device of FIG. 1;

FIG. 4 is a side elevation view of the food and beverage warming device of FIG. 1, wherein the opposite side thereof is a mirror image;

FIG. 5 is a top plan view of the food and beverage warming device of FIG. 1;

FIG. 6 is a bottom plan view of the food and beverage warming device of FIG. 1;

FIG. 7 is an exploded view of the food and beverage warming device of FIG. 1;

FIG. 8 is an isometric view of a cross section of the food and beverage warming device of FIG. 1;

FIG. 9 is a side elevation view of a cross section of the food and beverage warming device of FIG. 1;

FIG. 10 is a top plan view of a cross section of the food and beverage warming device of FIG. 1;

FIG. 11 is an isometric view of a food and beverage warming device according to another embodiment of the invention;

FIG. 12 is a partial isometric view of the food and beverage warming device of FIG. 11;

FIG. 13 is an exploded view of the food and beverage warming device of FIG. 11;

FIG. 14 is an isometric view of another embodiment of a food and beverage warming device according to the invention;

FIG. 15 is an exploded view of the food and beverage warming device of FIG. 14;

FIG. 16 is a partially exploded view of the food and beverage warming device of FIG. 14;

FIG. 17 is an exploded view of the food and beverage warming device of FIG. 14, wherein an eating utensil and can opener are also shown exploded from the food and beverage warming device; and

FIG. 18 is an isometric exploded view of the food and beverage warming device of FIG. 14, taken from an opposite side thereof.

### DESCRIPTION OF PREFERRED EMBODIMENTS

The present invention and the various features and advantageous details thereof are explained more fully with reference to the non-limiting embodiments described in detail in the following description.

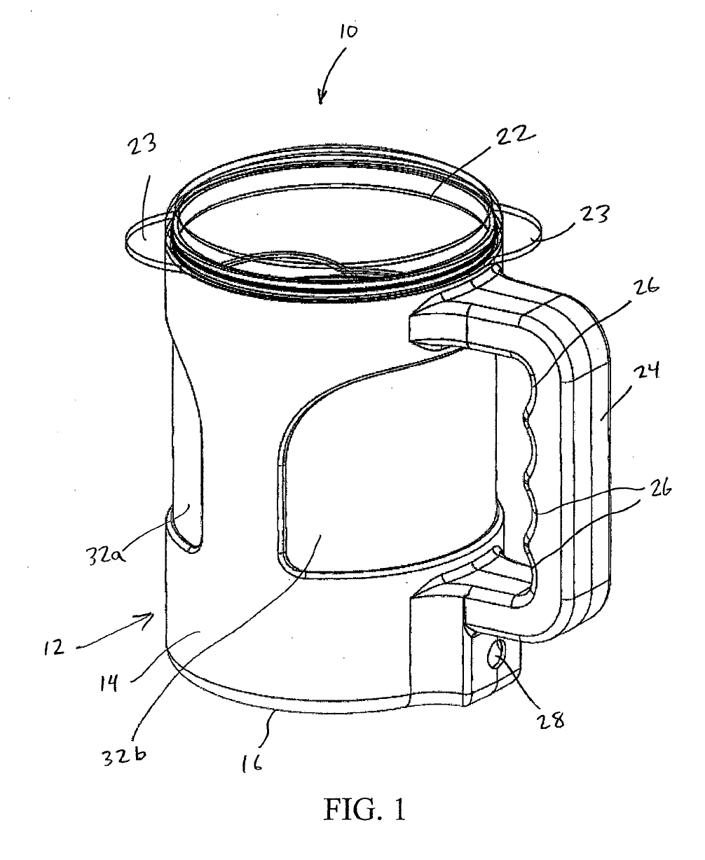

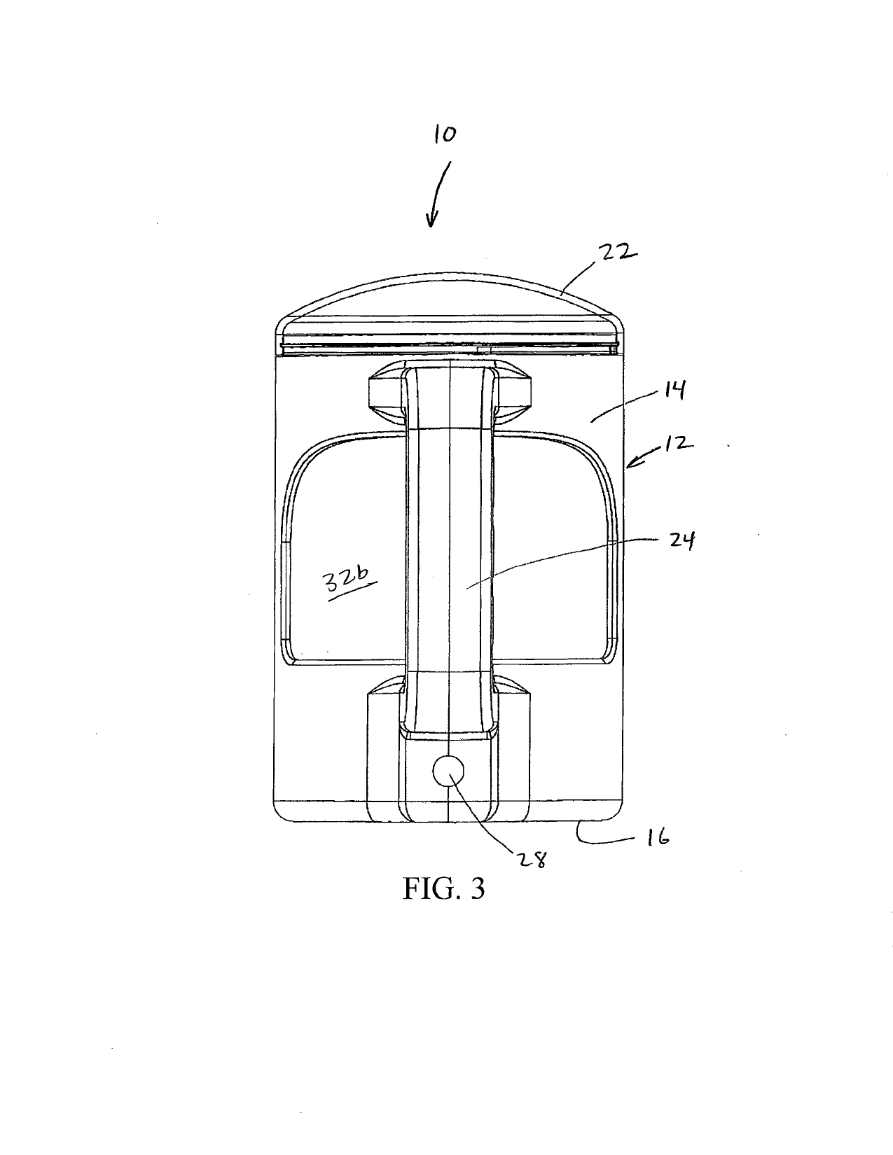

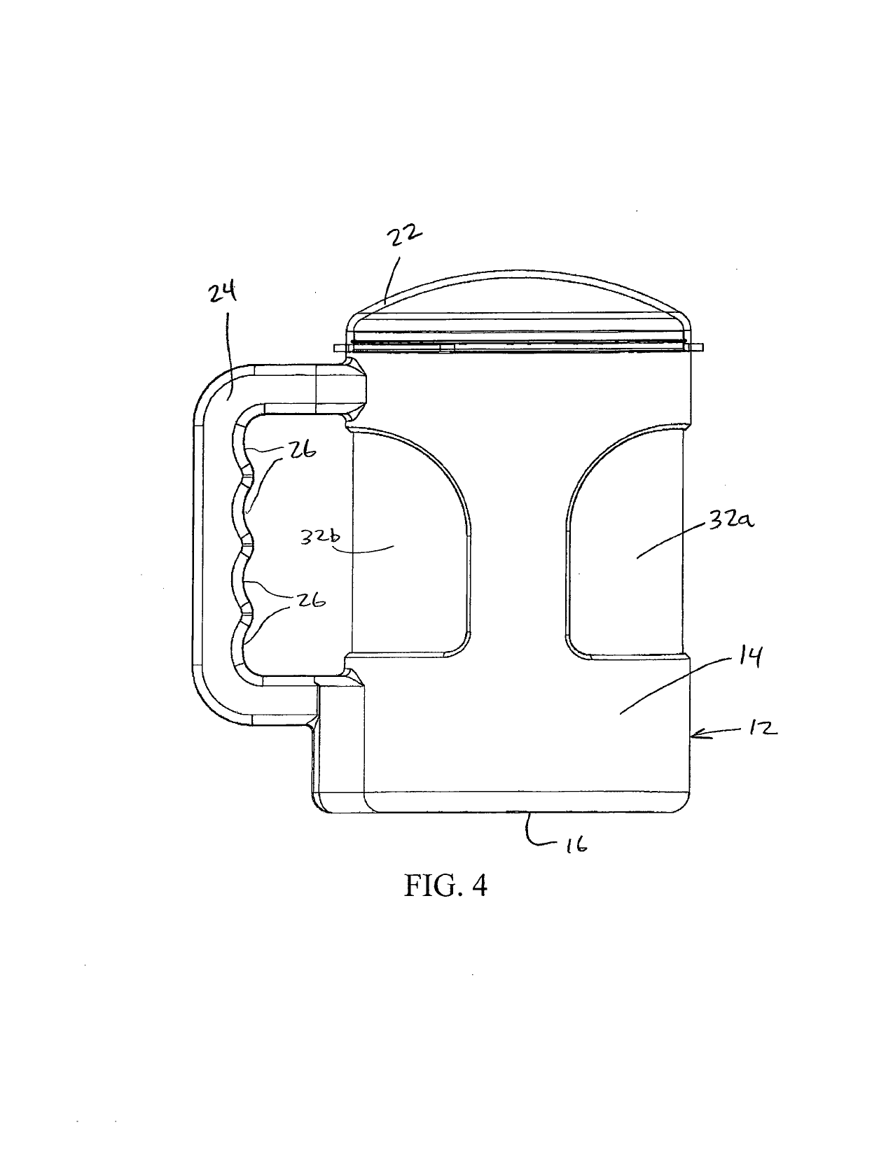

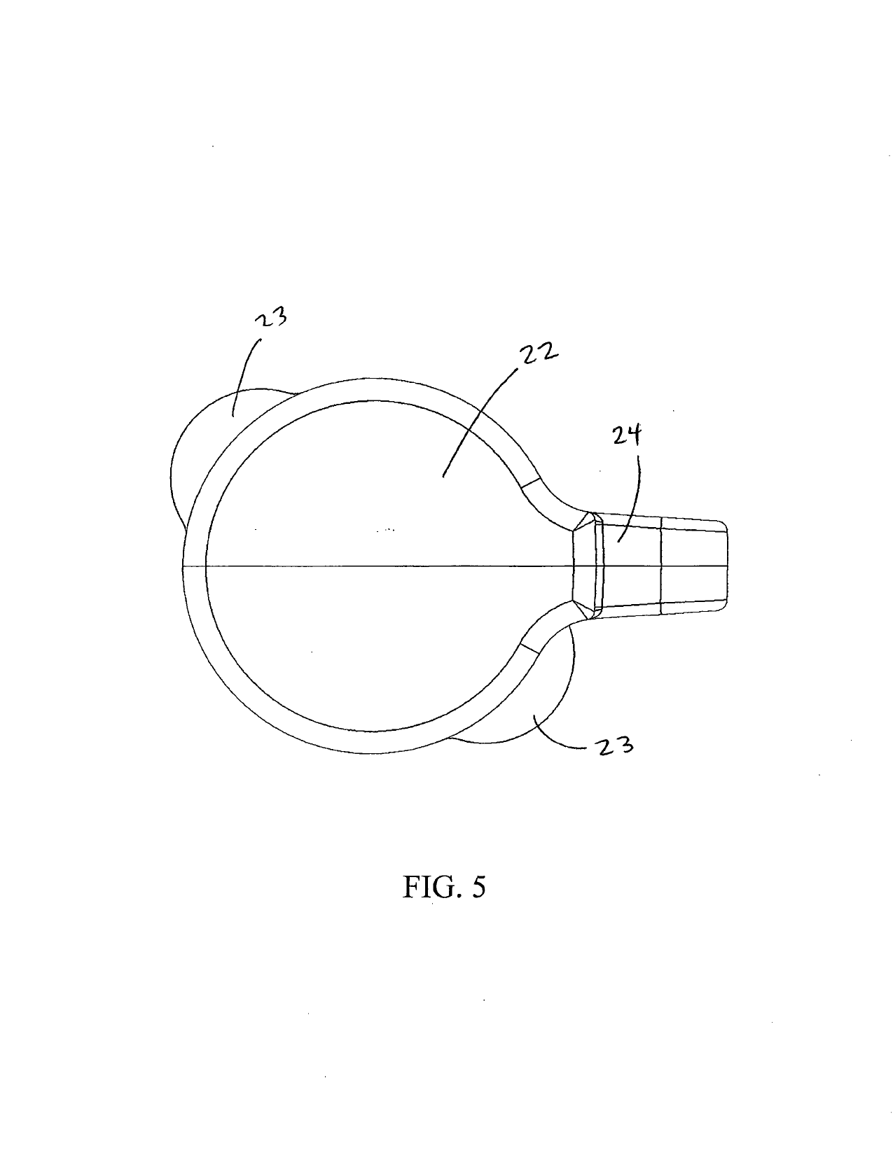

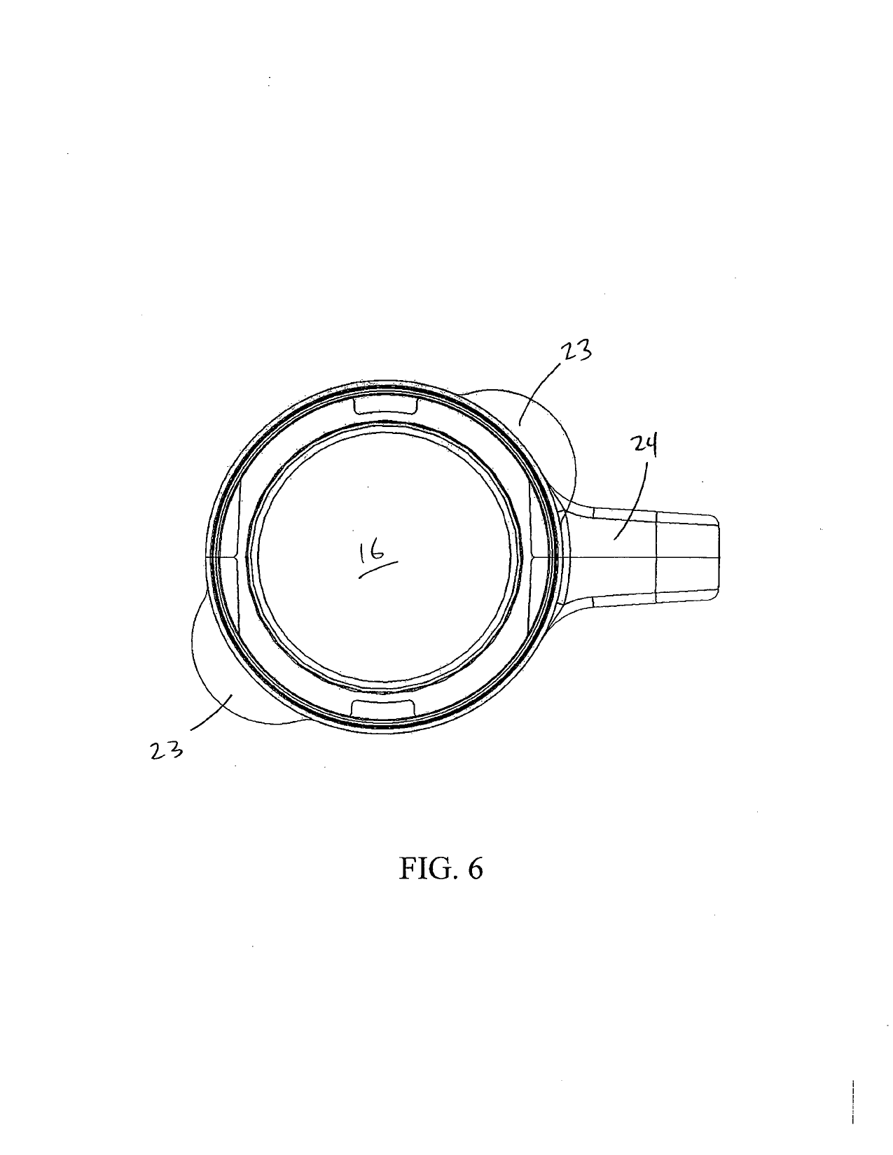

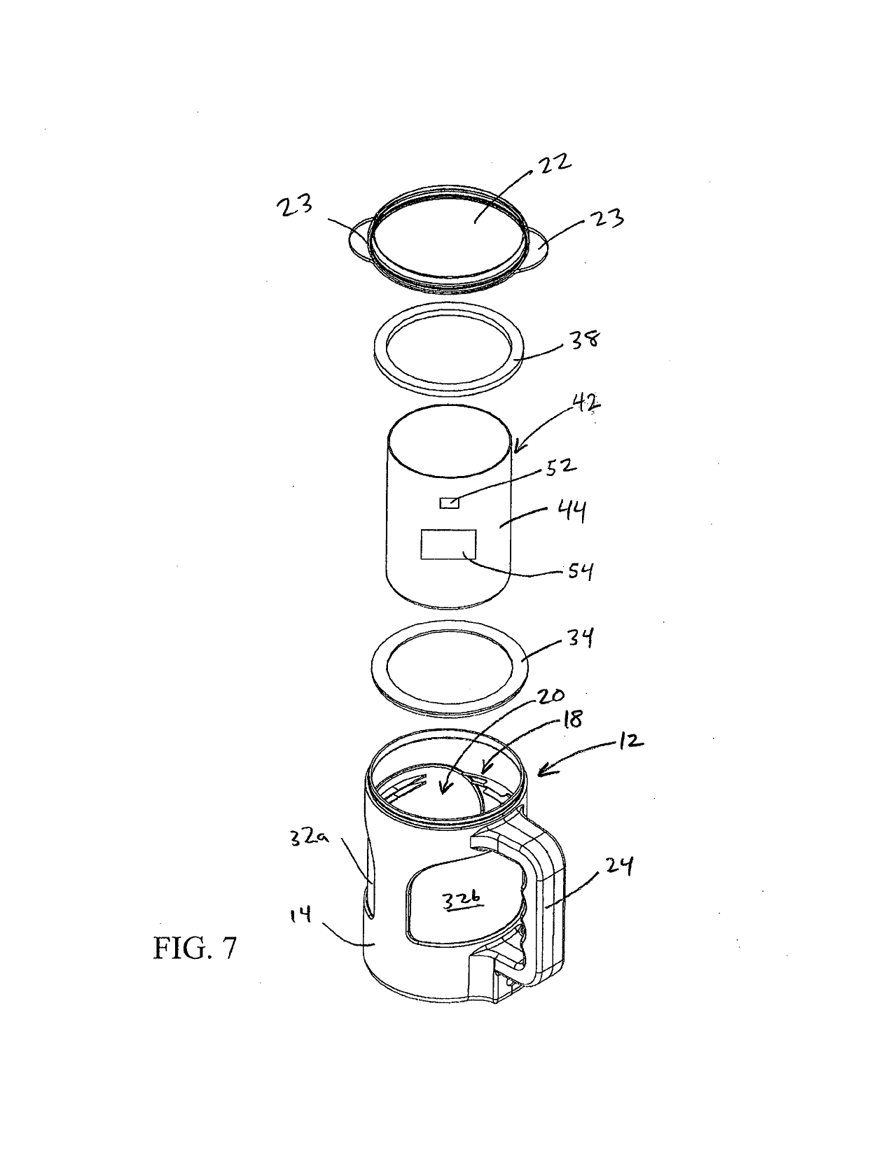

Referring now to the drawings, and initially to FIGS. 1-6, a food and beverage warming device 10 according to the invention is illustrated. Food and beverage warming device 10 includes a generally cylindrical housing 12. Housing 12 includes a sidewall 14 that extends around the entirety of the circumference of food and beverage warming device 10. Housing 12 further includes a bottom 16 and an opening 18 (see FIG. 7) opposite bottom 16 at the top 19 of the housing 12. A cavity 20 (see FIG. 7) is provided for and defined by sidewall 14 and bottom 16. Bottom 16 is substantially flat such that the food and beverage warming device 10 is capable of being positioned on a surface in a substantially sturdy manner such that the contents thereof are not spilled. A lid 22 may be provided and releasably securable to the upper edge of housing 12 to seal the cavity 20. Lid 22 may be engaged to the upper edge of sidewall 14 in any known manner. For instance, lid 22 may be configured to be snap fit on the upper edge of sidewall 14, or alternatively, lid 22 may be screwed onto the upper edge of sidewall 14 by way of one or more threaded fasteners or the like as is generally understood in the art. Lid 22 may further include one or more tabs 23 integrally formed therewith. Tabs 23 are configured for gripping by the user so that the user may remove the lid 22 from the food and beverage warming device 10. While housing 12 is disclosed and shown as being cylindrical, it is understood that the housing 12 may be any shape consistent with carrying out the objectives of the present invention.

A handle 24 is integrally formed with sidewall 14 of the housing 12. Handle 24 is generally sized and shaped to accommodate a user's hand as is generally understood. Handle 24 generally may have a sideways U-shape or any other such shape capable of accommodating the user's hands therethrough. Handle 24 may further include a number of gripping surfaces or grooves 26 formed in a surface thereof for receiving the user's fingers. Housing 12, lid 22, and handle 24 may be constructed from a plastic such as polypropylene or other similar such materials having similar characteristics. In this manner, food and beverage warming device 10 is relatively lightweight but is also substantially durable. Handle 24 may be disposed at or near the rear of the food and beverage warming device 12, or it may be positioned anywhere around the circumference thereof in keeping with the spirit of the invention.

A power input or connection 28 is provided on an external surface of sidewall 14. Power connection 28 is preferably a coaxial 12-volt DC power jack as is generally understood in the art, although a number of alternative types of power connections may be utilized in practicing the food and beverage warming device 10 of the invention. The power connection 28 may be nickel plated or may include any number of other plating materials sufficient to carry out invention. In one embodiment, the connection 28 accepts plugs having a 5.5 mm outer diameter and a 2.1 mm inner diameter, although alternative constructions are contemplated. For instance, the power connection 28 may comprise a standard electrical outlet plug configured to be interconnected with a power cord and a standard wall outlet or the like. Power connection 28 is interconnected with internal electrical circuitry as will be explained in detail herein. In this way, power connection 28 may be interconnected with, for instance, a cigarette lighter adapter of a vehicle or a similar such electrical connection such that power is relayed to the electrical circuitry to power the food and beverage warming device 10, as can be readily appreciated.

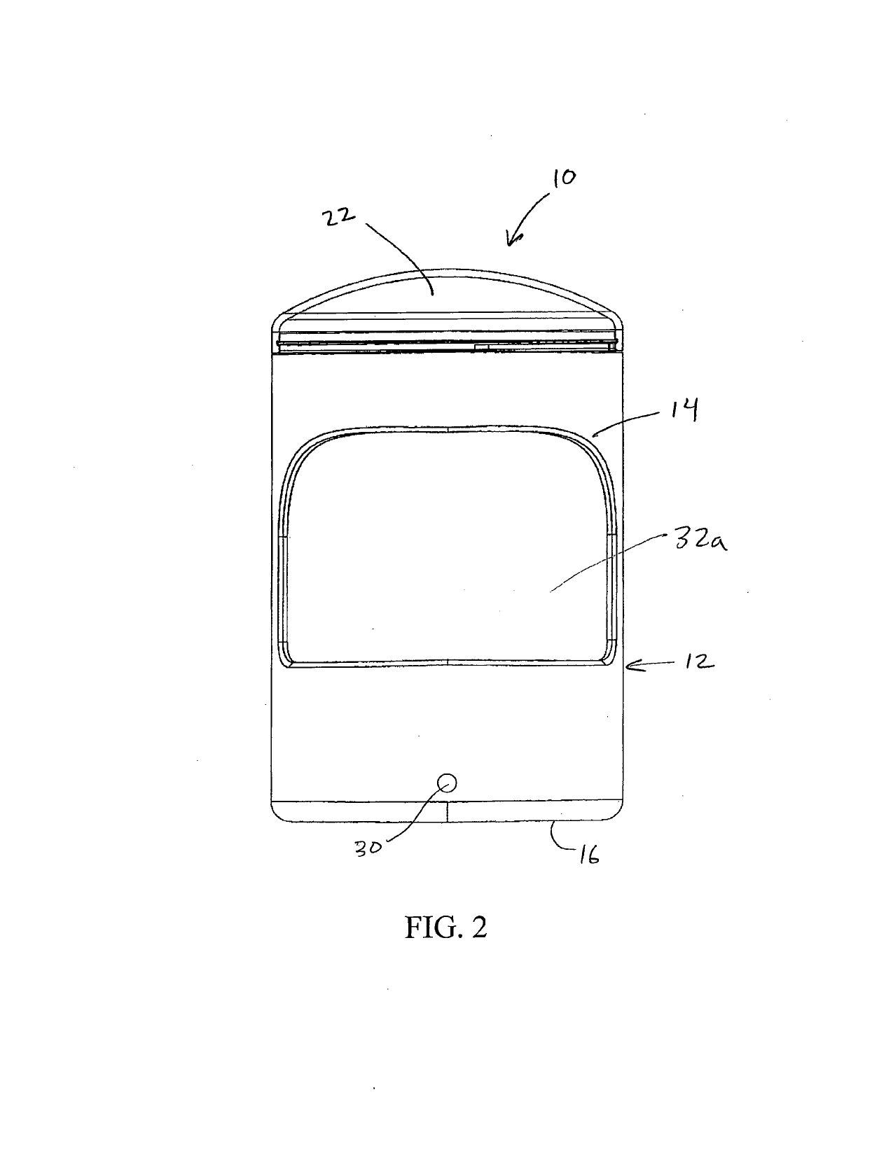

Referring now to FIG. 2 in particular, an opening is formed in a lower portion of the sidewall 14 for receiving a light-emitting diode (LED), bulb, or similar such illuminating member 30. Illuminating member 30 is powered by the power connection 28 by way of an electrical connection therebetween. Illuminating member 30 is configured to be illuminated when the food and beverage warming device 10 is connected to an external power source such that when the food and beverage warming device 10 is in use, the illuminating member 30 is illuminated and when the food and beverage warming device 10 is removed from the power source, the illuminating member 30 is not illuminated. In this manner, a user of food and beverage warming device 10 can easily determine whether the device is in operation. Alternative arrangements are contemplated and within the scope of the invention. For instance, the food and beverage warming device 10 may be configured such that the illuminating member 30 is illuminated when the heating element(s) of the food and beverage warming device 10 are at a temperature above or below a predetermined temperature. In the alternative, illuminating member 30 may be configured such that it is illuminated when the heating element(s) of the food and beverage warming device 10 are energized and it is not illuminated when the heating element(s) of food and beverage warming device 10 are de-energized. In this manner, the user of food and beverage warming device 10 is able to easily determine whether the food and beverage warming device 10 is actively being warmed as is readily understood. In another embodiment, the illuminating member 30 may be illuminated upon detection of a predetermined temperature within the cavity 20 of the housing 14.

Referring again to FIGS. 1-6, sidewall 14 may include a pair of open pockets 32 disposed around the perimeter thereof. Pockets 32 may be provided to enable heat to escape to prevent overheating of the device 10. As illustrated, a first pocket 32a is provided at a front portion of sidewall 14 and a second pocket 32b is provided at a rear portion of the sidewall 14. In particular, first pocket 32a is positioned a distance below the upper edge of the sidewall 14 and above the illuminating member 30. Second pocket 32b is disposed between an upper portion of the handle 24 and a lower portion of the handle 24.

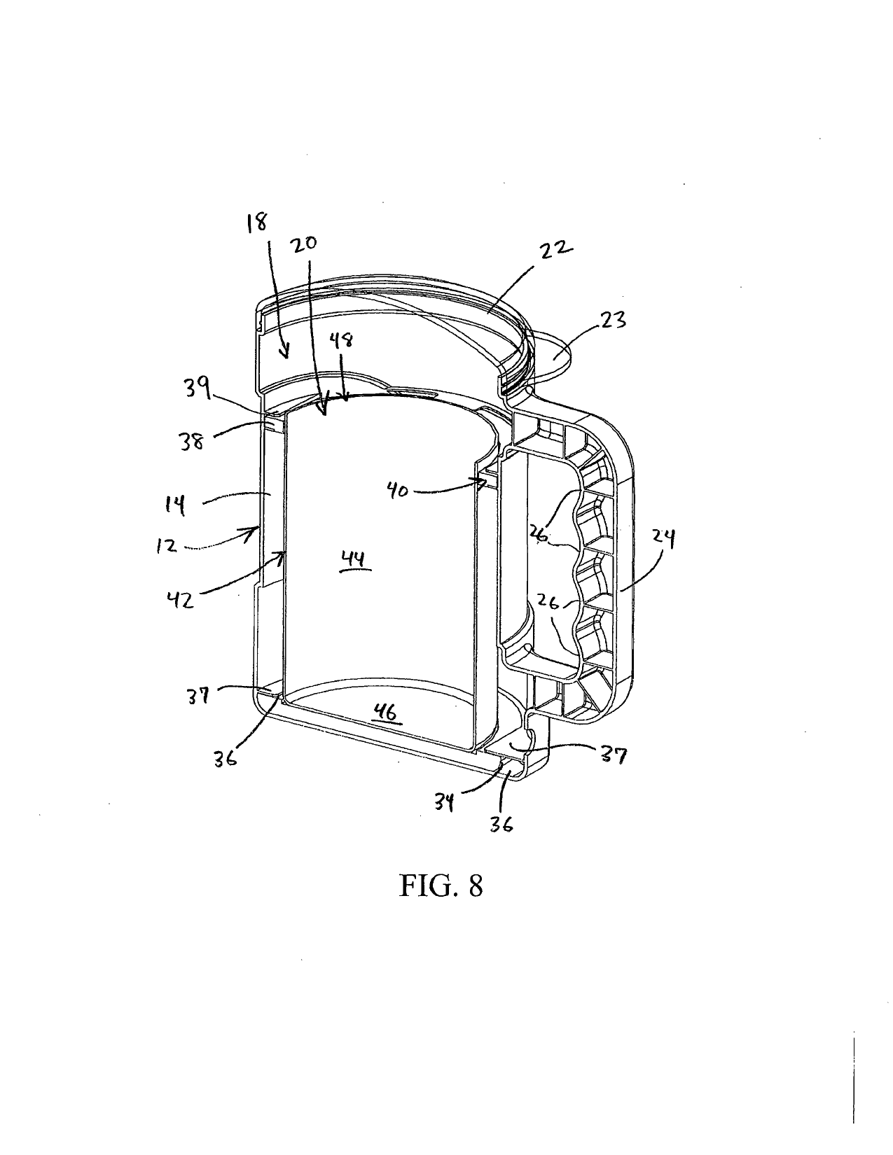

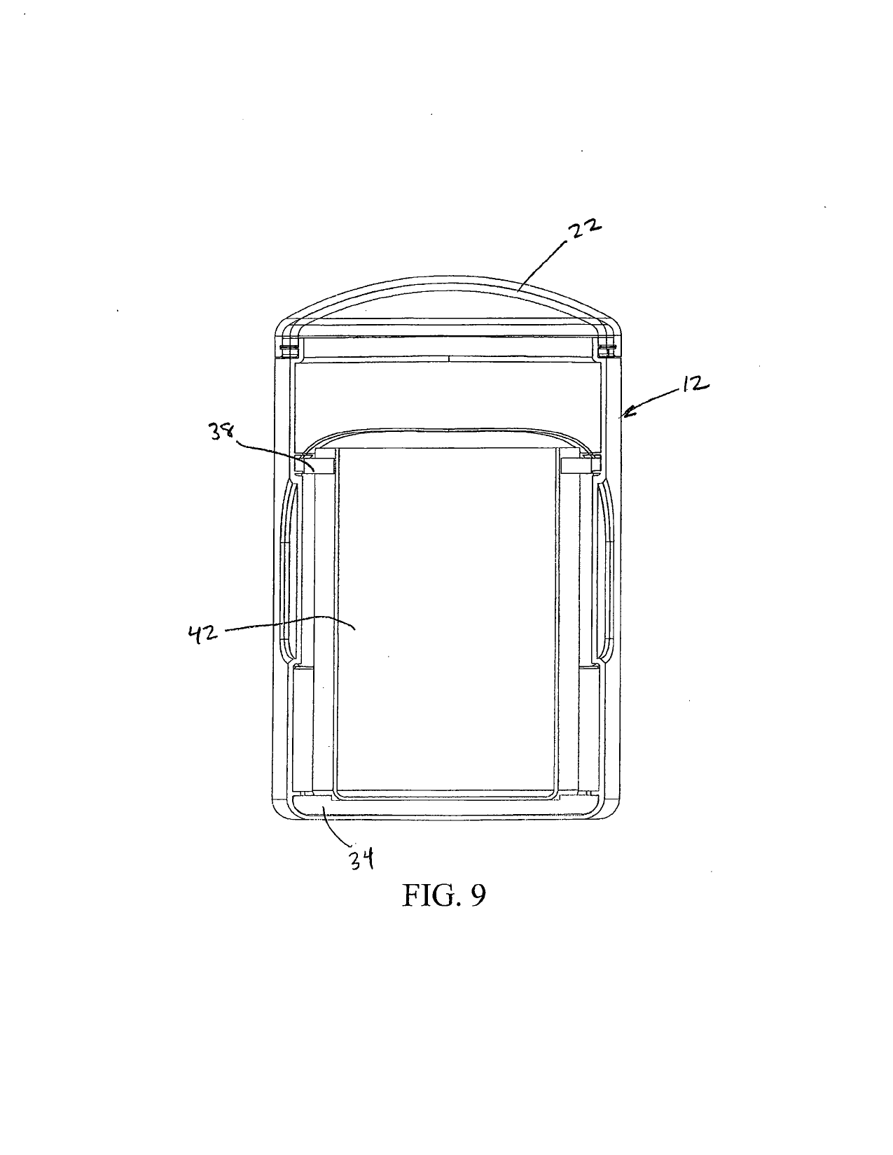

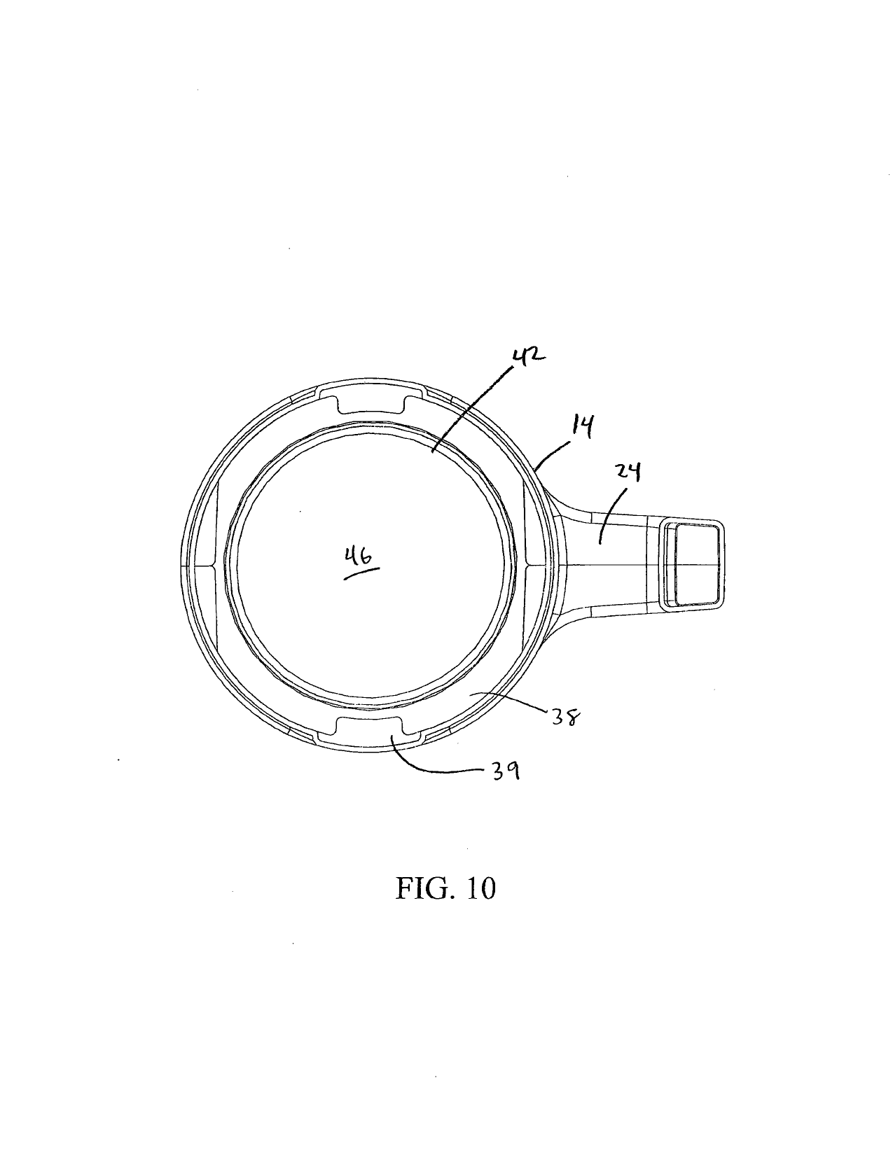

Now referring now to FIGS. 7-10, and initially to FIG. 7, an exploded view of one construction of the food and beverage warming device 10 is shown. Cavity 20 may include one or more retaining elements configured to secure a container 42 within the cavity 20 as will be discussed herein. In particular, cavity 20 may include a lower retaining ring 34 on or near a floor 36 defined by the bottom wall 16 and retained by a number of spaced flanges 37 (see FIG. 8) disposed around an inner circumference of the housing 14 to cooperate with floor 36 to define a channel 40a for securely receiving lower ring 34. An upper retaining ring 38 is provided and received in a circumferential channel 40b that extends around an interior of the housing 14 and defined by a number of flanges 39 (see FIG. 8) disposed around the circumference of the housing 14. Upper retaining ring 38 is similarly positioned and configured for retaining the container 42 within cavity 20.

Rings 34, 38 may be constructed from a Garolite material or similar such phenolic, as is generally understood. The rings 34, 38 preferably have a thickness of approximately 3/16 of an inch and serve to position a generally cylindrical container 42 that is received in the cavity. In particular, the two retaining rings 34, 38 receive the container 42 through the central holes thereof. The rings 34, 38 are configured to snugly receive the container 42 such that a tight-fitting connection is made between the rings 34, 38 and the container 42. Container 42 may have any shape desired and is not necessarily limited to being cylindrical. Moreover, container 42 may have a shape dissimilar from that of the housing 12.

Container 42 is constructed from aluminum or a similarly conductive material. Container 42 is sized and shaped similarly to housing 12. Container 42 includes a circumferential sidewall 44, a bottom wall 46 and an opening 48 opposite the bottom wall 46 for receiving a can as will be explained in detail. In a preferred embodiment, a gap is provided between sidewall 44 and an interior wall of housing 12 to serve as a thermal break therebetween to provide a heat sink.

A thermostat 52 may be provided on the outer surface of sidewall 44 of container 42. Thermostat 52 is configured to monitor and regulate the temperature of the container 42. Thermostat 52 is interconnected between the power source, e.g., a vehicle cigarette lighter adapter and a heating element 54 of the food and beverage warming device 10 to ensure that the temperature of the food and beverage warming device 10 does not exceed a predetermined temperature. In one embodiment, the thermostat 52 is configured to ensure that the temperature within cavity 20 does not exceed 185 degrees Fahrenheit. In another embodiment, thermostat 52 is configured to prevent the temperature of food and beverage warming device 10 from exceeding between exceeding 185 degrees Fahrenheit or falling below approximately 145 degrees Fahrenheit. Specifically, thermostat 52 is configured such that when a desired temperature is reached, the power to the heating element 54 is shut off such that the food and beverage warming device 10 does not overheat and that when the temperature falls below a predetermined temperature, power is restored to the heating elements to make sure that the contents of food and beverage warming device 10 do not become too cool for consumption. Depending on the ambient air temperature, the cycling on and off of the heating element may occur approximately every two minutes. Accordingly, food and beverage warming device 10 is configured to not only provide a food or beverage item that is of a preferred temperature, but it also ensures that food and beverage warming device 10 does not reach unsafe temperatures in which the can of food and beverage warming device 10 may explode or start on fire.

Heating element 54 is coupled to the external wall of sidewall 44. Heating element 54 may be a 12-volt, 60 Watt silicon rubber heat strip like the kind manufactured by Electro-Flex Heat Inc. Alternatively, heating element 54 may be another similar type of heating element. Heating element 54 may be coupled to the sidewall 44 by way of an adhesive backing or the like or by way of a fastener or any other suitable type of connector. The heating element 54 is electrically operably interconnected with the power source via power connection 28. In particular, heating element 54 is wired to the power input 28 such that the heating element 54 is electrically powered so as to provide heat to the container 42 as is generally understood. As discussed previously, heating element 54 and power input 28 are also in operable communication with the thermostat 52 such that when the thermostat detects a temperature above or below a given threshold, the power input 28 energizes or de-energizes the heating element 54.

Food and beverage warming device 10 is capable of use and operation in a wide number of locations. In particular, food and beverage warming device 10 is capable of use in a vehicle while traveling. In this manner, the user of food and beverage warming device 10 can warm a can of soup or similar such food or beverage item while they travel so that they can eat while traveling.

In operation, the user of food and beverage warming device 10 inserts a can of food such as soup, spaghetti, or a similar such can of food or a can having a beverage to be heated, such as coffee, tea, water, or broth. The can is inserted into the container 42 unopened such that the contents may be warmed while still in the can. The can is received snugly within container 42 such that heat transfer may occur from the container 42 to the can. The lid 22 is then placed over opening 18 to improve the efficacy of the heat transfer and prevent undesired heat loss through the opening of the housing 14. The food and beverage warming device 10 is then interconnected with a power source such as a cigarette lighter adapter in the vehicle. This may be accomplished via a coaxial power cable or similar such power connector. Once connected to the power source, thermostat 52 of food and beverage warming device 10 begins to monitor the temperature of container 42. As long as the temperature of container 42 is below a maximum predetermined temperature, for example, 185 degrees Fahrenheit, the thermostat allows the heating element 54 to be energized by the power source via the electric circuitry of the food and beverage warming device 10. While the heating element 54 is being energized, illuminating member 30 is illuminated to convey to the user that the container 42 is being warmed. After the container 42 reaches the predetermined maximum temperature, the thermostat sends a signal to the heating element to de-energize the heating element 54. Once the heating element 54 is de-energized, the illuminating member 30 is shut off to indicate to the user that the food and beverage warming device 10 is no longer being warmed. When the container 42 reaches a predetermined minimum temperature, for instance, 145 degrees Fahrenheit, the thermostat sends a signal via the food and beverage warming device's electrical circuitry to energize the heating element 54. This process is continually repeated over a period of approximately two minutes depending on the ambient temperature where the heating is taking place. In this manner, food and beverage warming device 10 is configured to prevent the can from being overheated and potentially exploding while still being able to keep the contents thereof at a desirable temperature for consumption.

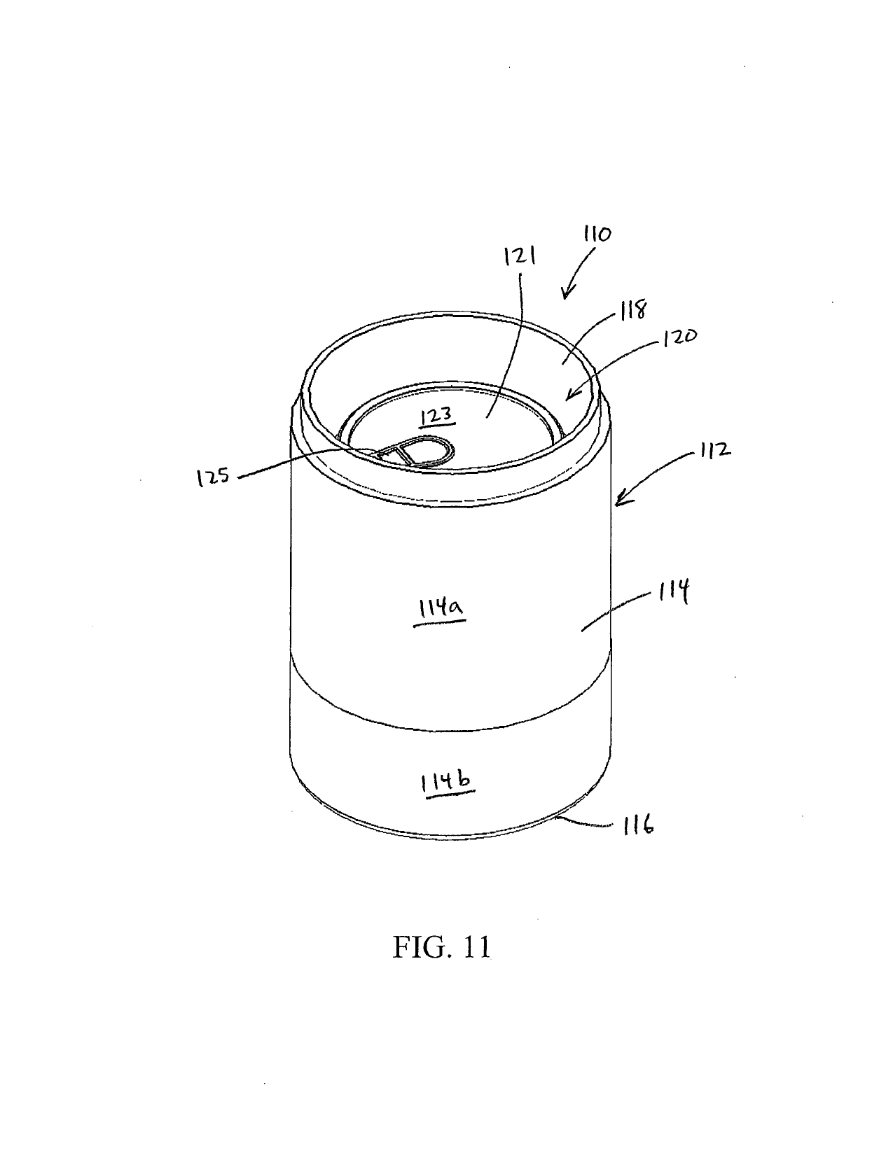

Referring now to FIGS. 11-13, another embodiment of the food and beverage warming device 110 is illustrated. In this embodiment food and beverage warming device 110 includes a generally cylindrical housing 112 having a pair of sidewall sections 114a, 114b that are coupled to one another to define an interior cavity 120 along with bottom 116. Housing 112 includes an opening 118 opposite the bottom 116 for receiving a can 121 holding soup or similar food or drink item. Can 121 includes a lid 123 that is easily removable via a tab 125 disposed on lid 123. In this manner, can 121 may be inserted into food and beverage warming device 110 while still sealed and heated prior to removal of the lid 123 for consumption of the soup or other food or beverage.

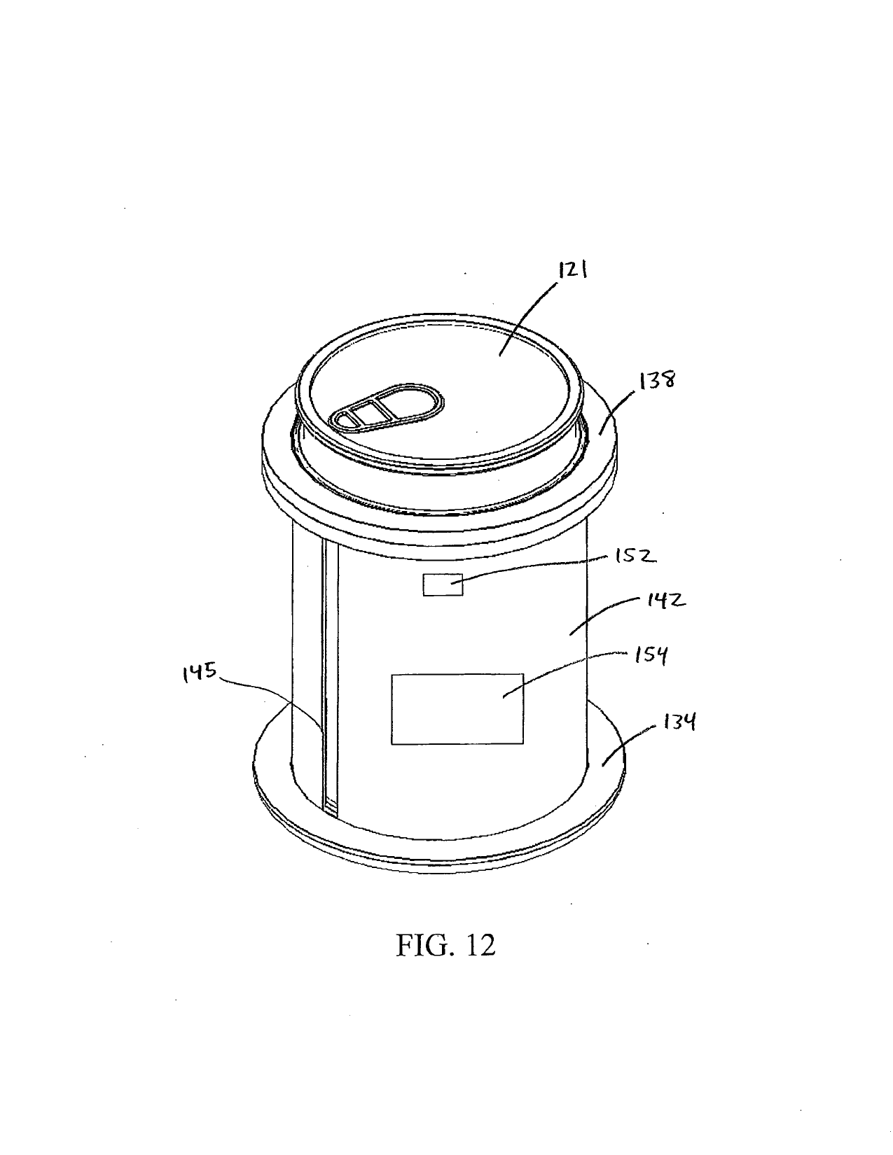

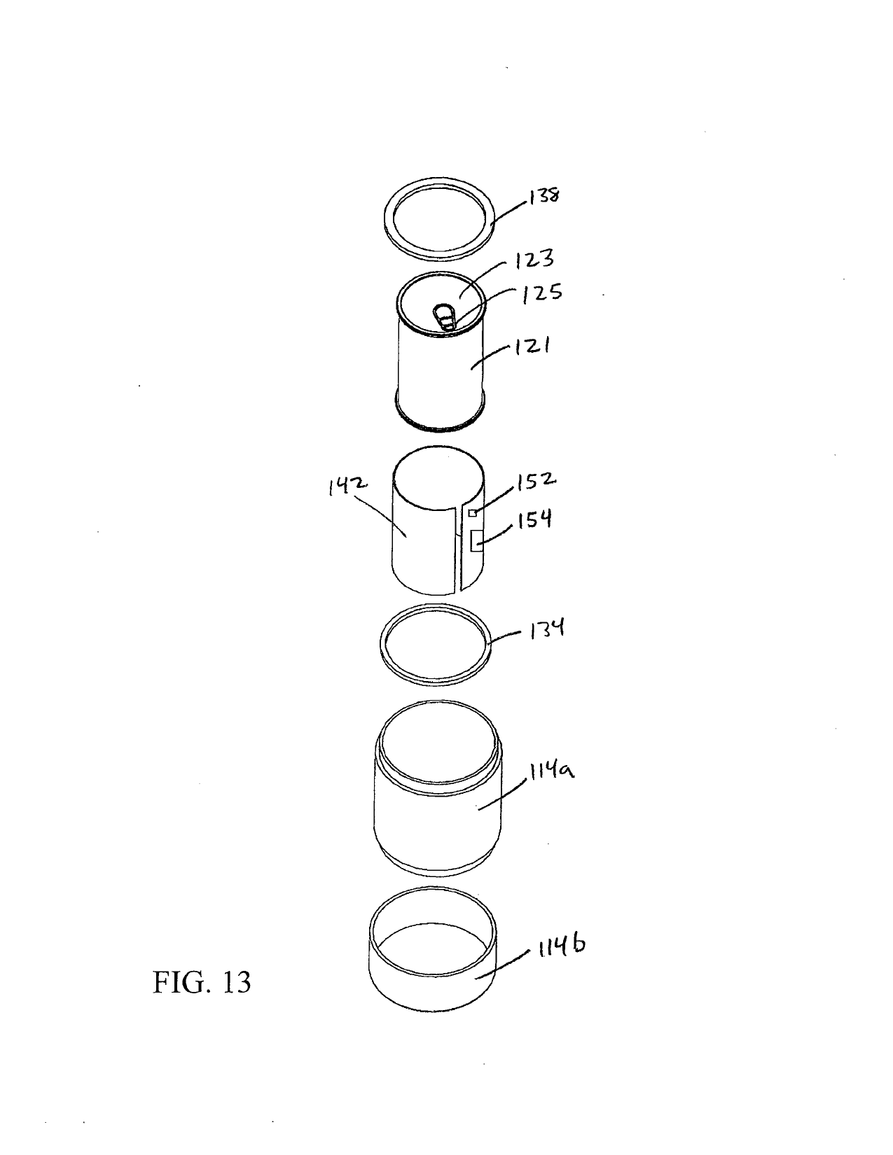

Referring now to FIG. 12 in particular, can 121 is shown received between a container 142 and a pair of rings 134, 138. As shown, a sidewall 144 of container 142 includes a gap 145 in order to accommodate cans 121 of varying size. That is, container 142 may be configured to expand slightly to accommodate a can 121 having a larger circumference than that of the container 142 when it is in its non-expanded configuration. However, it is readily understood that sidewall 144 may comprise a unitary construction devoid of a gap 145. Rings 134, 138 are configured to retain the can 121 in cavity 120 as in the previous embodiment. In this manner, rings 134, 138 are constructed in much the same manner as in the previous embodiment. Ring 134 is configured to be received within the bottom of sidewall 114b as best seen in FIG. 13. As is generally understood, the food and beverage warming device 110 of the present embodiment may be altered to comprise any of the features of the previous embodiment, and similarly, the food and beverage warming device 10 of the previous embodiment may be modified to incorporate the aspects of the present embodiment in keeping with the spirit of the present invention.

Referring again to FIGS. 11-13, food and beverage warming device 110 of the present embodiment is configured to operate in much the same manner as that of the previous embodiment. That is, food and beverage warming device 110 includes a thermostat 152 on a surface thereof for monitoring and regulating the temperature of the food and beverage warming device 110. A heating element 154 is mounted by way of an adhesive or other such mechanical connection to the outside of container 142 to selectively warm the container 142 such that can 121 is heated by way of heat transfer therethrough.

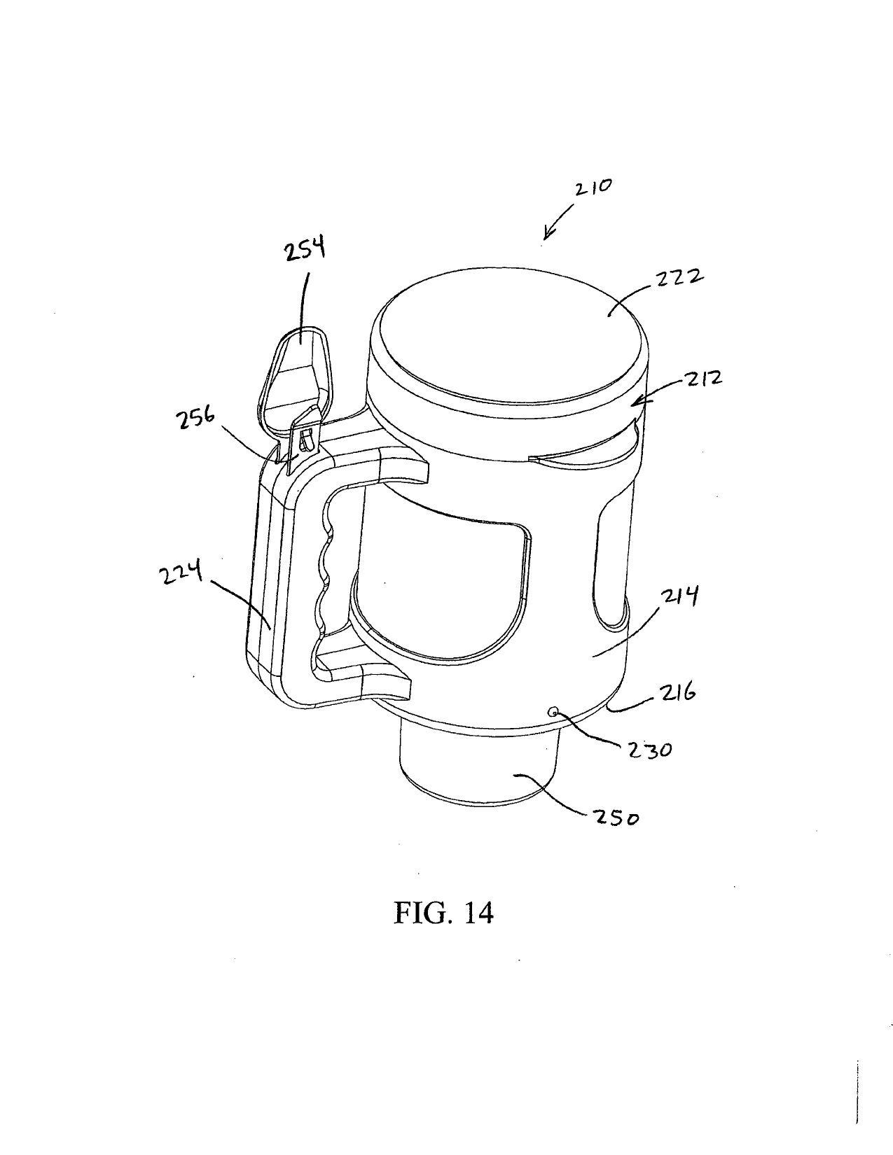

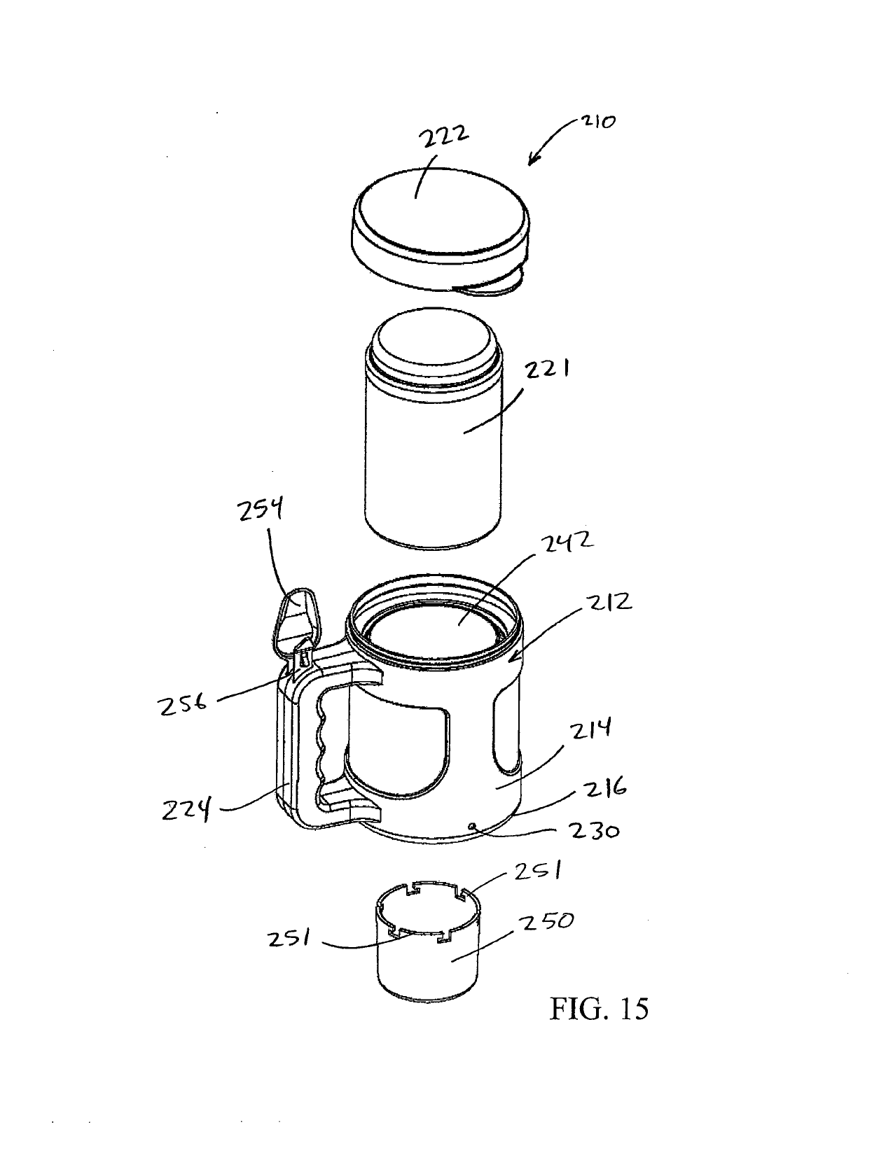

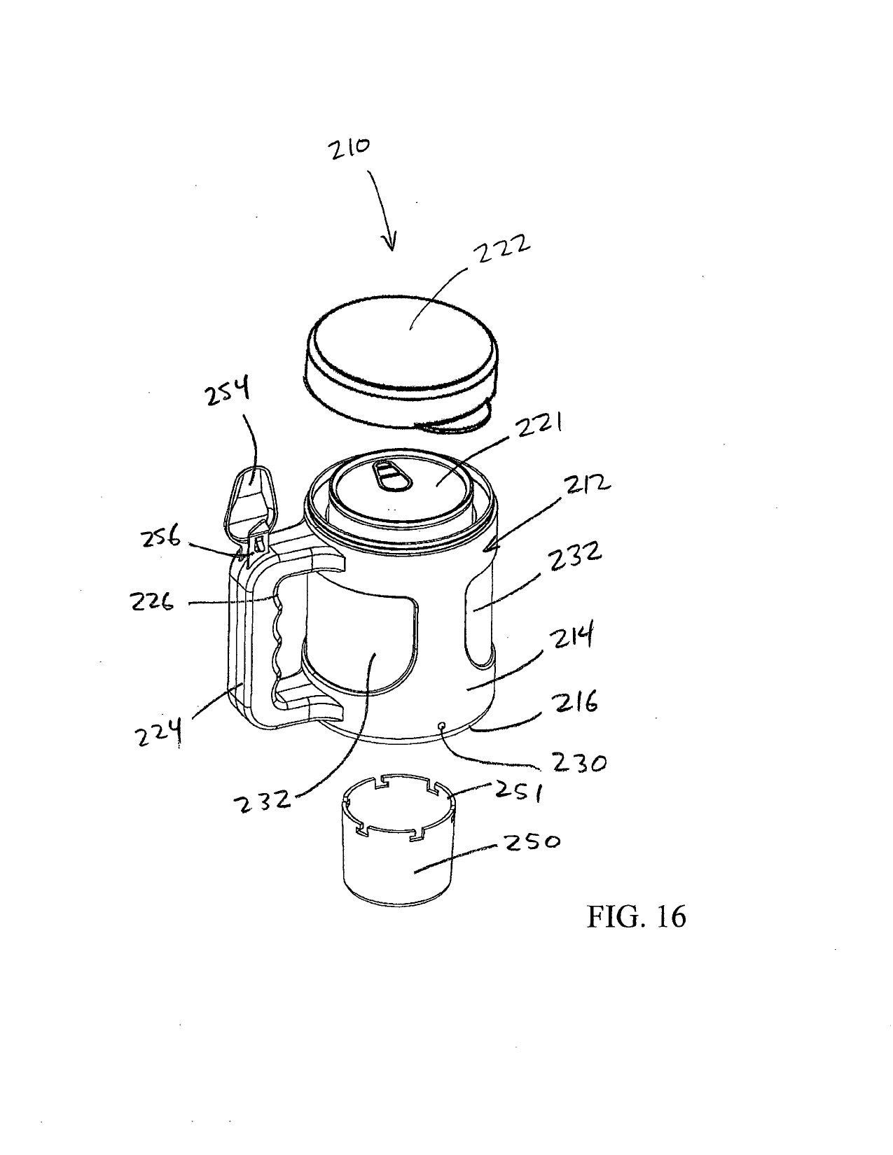

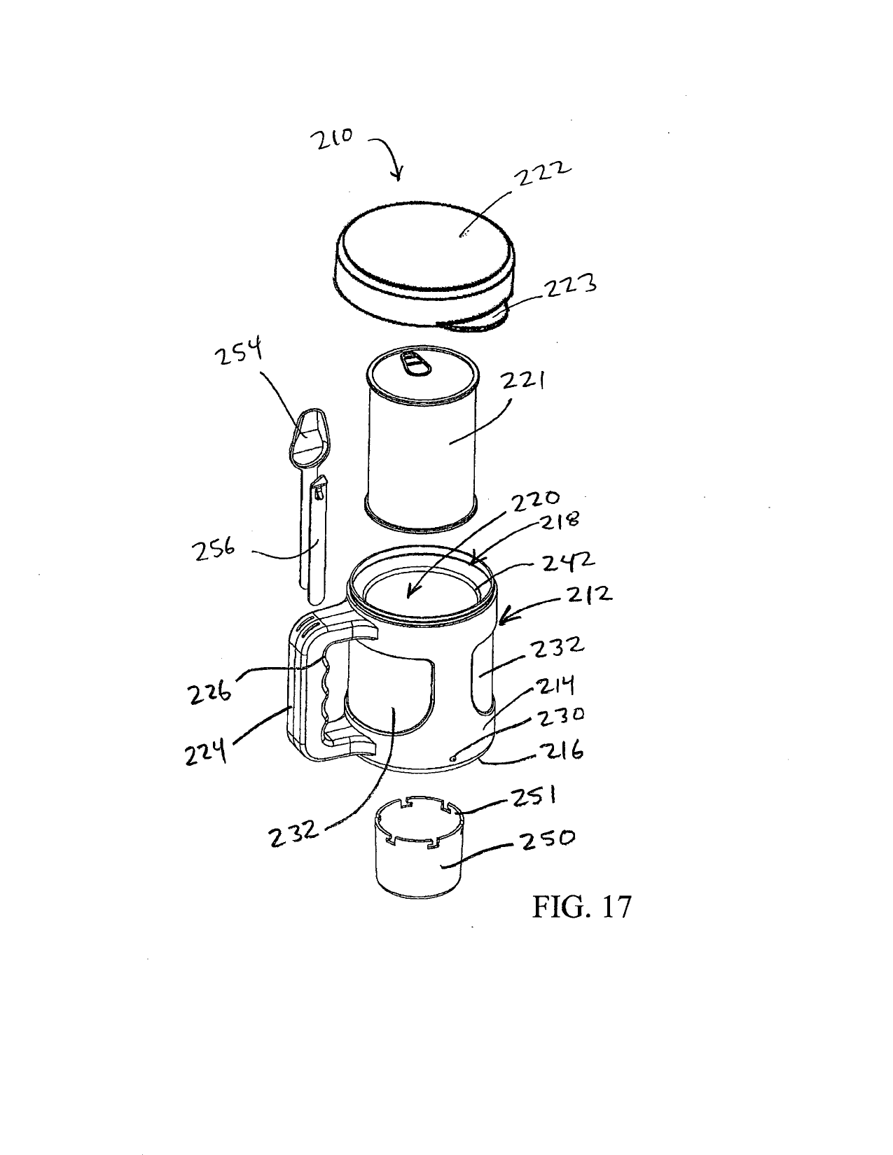

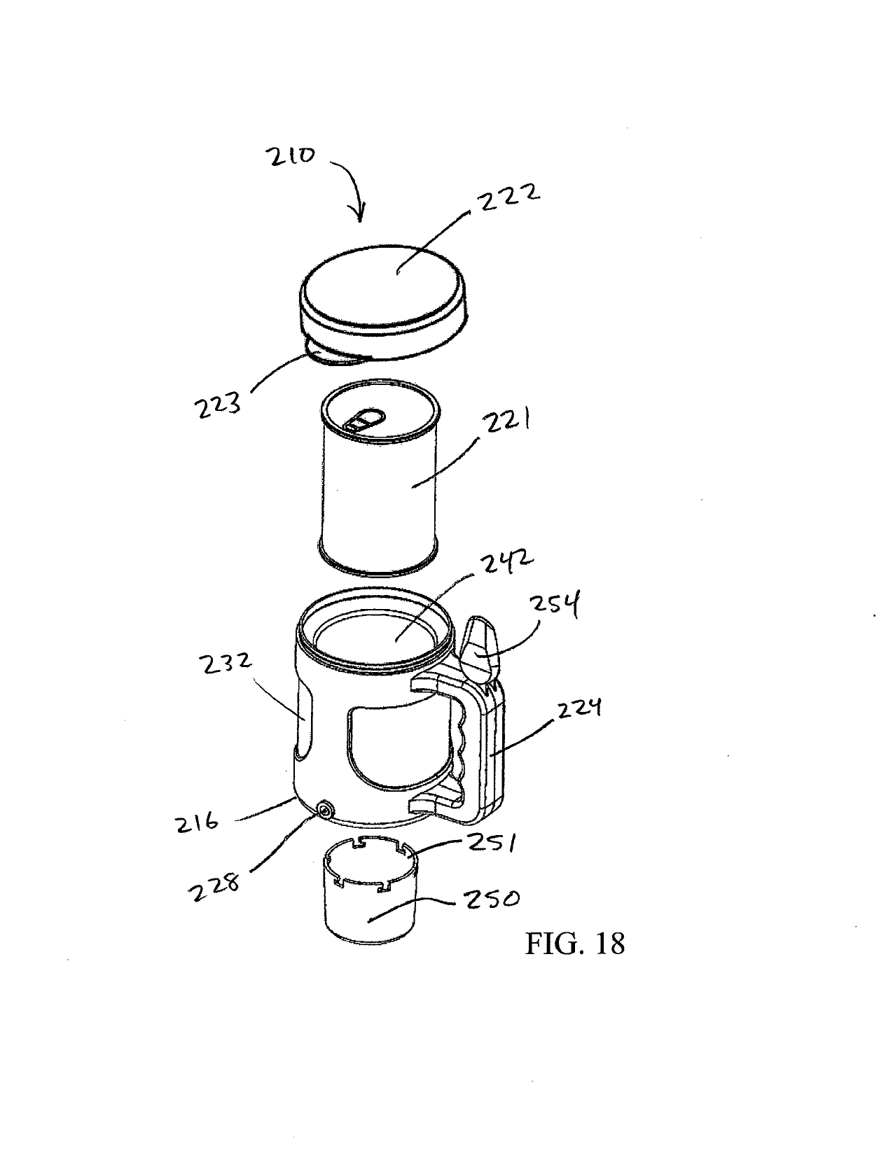

Now referring to FIGS. 14-18, yet another embodiment of food and beverage warming device 210 is illustrated. The food and beverage warming device 210 of this embodiment is substantially similar to that of the previous embodiments, and it operates in much the same manner. In the present embodiment food and beverage warming device 210 includes a generally cylindrical housing 212 having a sidewall 214 extending around the entire circumference of the housing 212. A bottom 216 is opposite an opening 218 to define a cavity 220 for receiving a container 242. A lid 222 is provided for preventing spilling from the food and beverage warming device 210 and includes a pair of tabs 223 for assisting a user in removing the lid. An upper edge of sidewall 214 is substantially flush or parallel with a top of can 221. In this way, a user of food and beverage warming device 210 is able to sip or drink directly from the food and beverage warming device 210. Further, by providing can 221 flush with food and beverage warming device 210 housing 212, spillage back into the food and beverage warming device 210 cavity 220 is avoided. This is particularly desirable to avoid soiling the interior of the food and beverage warming device 210, thereby requiring cleaning of food and beverage warming device 210. In this manner, food and beverage warming device 210 is kept relatively clean for subsequent uses. Food and beverage warming device 210 further includes an illuminating member 230 as in the previous embodiments. Sidewalls 214 include a pair of pockets 232 as in the previous embodiments. Food and beverage warming device 210 further includes a power connection 228 as in the first embodiment.

Food and beverage warming device 210 of the present embodiment includes a base 250 coupled to bottom 216. Base 250 is configured to allow the food and beverage warming device 210 to be securely held in a standard cup holder of a vehicle, e.g., having a diameter of approximately 6 cm or 2.5 inches. In this manner, food and beverage warming device 210 is maintained substantially stable within the cup holder to prevent accidental spilling. Base 250 may be constructed from the same material comprising housing 212. Base 250 includes a number of teeth 251 around an upper edge thereof for engaging bottom 216 of housing 212 to secure base 250 thereto. Bottom 216 preferably comprises a plurality of corresponding receivers (not shown) adapted for selective engagement with teeth 251 as can be readily understood.

Food and beverage warming device 210 further includes a pair of apertures 252 or slots in the handle 224 of housing 212. Understandably, apertures or slots 252 may be located elsewhere on the housing 212. Handle 224 includes a number of recesses or grooves 226 as in the previous embodiment for receiving a user's fingers. The apertures 252 are configured to securely hold an eating utensil 254, such as a spoon, fork, or a combination thereof. The apertures 252 are also configured to secure a can opener 256. Can opener 256 may be constructed from plastic, metal, or any other suitable material as is readily appreciable. Apertures 252 may comprise alternative sizes and shapes to accommodate a variety of different utensils or attachments. Further, apertures 252 could comprise a single aperture 252 or a plurality of additional apertures 252 in keeping with the spirit of the present invention.

Utensil 254 of the invention is preferably configured to cooperate with the can 221. In particular, utensil 254 includes a blunt, flat front edge that is configured to aid the user in scraping food from can 221. In this way, the user is able to easily remove the contents from a standard can 221 much more easily than in using a standard spoon having rounded edges that are not adapted to cooperate with a cylindrical can 221. Utensil 254 may be constructed from a plastic, metal, or any other material sufficient for carrying out the invention. Utensil 254 is preferably reusable, and it may be cleaned after use for subsequent reuse. Alternatively, utensil 254 may be disposable.

In one alternative embodiment, can 221 may comprise a reusable can that is configured to selectively receive food or beverages. In this manner, the food and beverage warming device 210 may be used to heat items that would not necessarily be sold in a conventional soup can-sized container. Accordingly, food and beverage warming device 210 is capable of heating a plurality of different foods and beverages that would not otherwise be possible. For instance, can 221 may be used to heat a hot dog or similar food item. Reusable can 221 is preferably constructed from stainless steel or a similar material.

Further, it can be readily appreciated that the food and beverage warming devices 10, 110, 210 according to the present invention may comprise a number of alternative designs in keeping with the invention. For instance, housings 12, 112, 212 may include additional gripping surfaces or it may be specifically contoured to receive a user's hand around a part thereof. In addition, housings 12, 112, 212 may include additional foam or similar such material around the outside thereof for providing a comfortable grip and/or additional insulation. A number of alternative features may be incorporated into the housing as well.

It is intended that the appended claims cover all such additions, modifications and rearrangements. Expedient embodiments of the present invention are differentiated by the appended claims.

I claim:

1. A food and beverage warming device comprising:
a housing defining a cavity and including a bottom wall and an opening opposite the bottom wall;
a container receivable within the cavity configured for receiving a food or beverage holder;
at least one heating element coupled to the container;
at least one sensor coupled to the container to detect a temperature thereof; and
a power input operably coupleable to a power source for selectively powering the at least one heating element and the at least one sensor;
wherein the at least one sensor is operably coupled with the heating element such that when the sensor detects a temperature above a predetermined maximum temperature the heating element is de-energized and when the sensor detects a temperature below a predetermined minimum temperature, the heating element is energized.

2. The food and beverage warming device of claim 1, further comprising a gap between the housing and the container to provide a heat sink therebetween.

3. The food and beverage warming device of claim 1, wherein the housing includes at least one pocket formed over a portion of the housing to enable heat to escape the housing to prevent overheating.

4. The food and beverage warming device of claim 1, wherein the housing is constructed of a non-conductive material and the container is constructed from a conductive material.

5. The food and beverage warming device of claim 4, wherein the non-conductive material is a plastic and the conductive material is a metal.

6. The food and beverage warming device of claim 1, further comprising a handle coupled to the housing and configured for grasping by a user of the device.

7. The food and beverage warming device of claim 1, further comprising a lid selectively receivable over the opening.

8. The food and beverage warming device of claim 1, further comprising at least one selectively illuminable element, wherein the selectively illuminable element is configured to relay a predetermined message to the user of the device.

9. The food and beverage warming device of claim 8, wherein the illuminable element is configured to relay to the user at least one of a state of the heating element and a temperature detected by the at least one sensor.

10. The food and beverage warming device of claim 1, further comprising a retaining assembly secured within the housing and configured to securely engage the food or beverage holder within the container.

11. The food and beverage warming device of claim 10, wherein the retaining assembly comprises an upper channel and a lower channel wherein the upper channel and the lower channel are configured to receive a retaining element configured to securely receive the food or beverage holder.

12. The food and beverage warming device of claim 11, wherein the upper channel and the lower channel are defined by a plurality of flanges disposed on an interior surface of the housing and a floor and upper edge of the housing respectively.

13. A device for warming a food or beverage in the original container of the food or beverage, the device comprising:
a housing including at least one sidewall, a bottom wall, and an opening opposite the bottom wall and defining a cavity;
a container receivable within the cavity of the housing and configured to receive the original container of the food or beverage;
a heating element operably coupled to the container to warm the contents of the container;
a temperature sensor operably coupled to the container and configured to detect a temperature of the original container;
a power input operably coupled to the heating element and the temperature sensor and configured to selectively energize and de-energize the heating element in response to a temperature detected by the temperature sensor.

14. The device of claim 13, further comprising a retainer assembly secured within the housing and configured to engage the original container.

15. The device of claim 14, wherein the retainer assembly comprises an upper ring and a lower ring disposed within the cavity and configured to engage an upper end and a lower end of the original container.

16. The device of claim 13, wherein the container comprises a gap extending along a longitudinal length thereof, wherein the gap enables the container to expand to receive original containers of varying sizes.

17. The device of claim 13, further comprising a base selectively securable to the housing and configured to support the housing on a support surface.

18. The device of claim 13, further comprising at least one slot formed in the housing and configured to receive a utensil for use with the original container.

19. A warming device for the contents of a holder of a consumable item, the device comprising:
a cylindrical housing constructed from a non-thermally conductive material and including a circumferential sidewall, a bottom wall and an opening opposite the bottom wall and defining a cavity therebetween;
a cylindrical container constructed from a thermally conductive material and configured to be received within the cavity of the housing for receiving the holder of the consumable item;
a retaining assembly secured within the cavity and configured to engage the holder of the consumable item;
a thermostat operably coupled within the cavity for detected a temperature thereof;
at least one heating element operably coupled within the cavity for applying heat to the cavity to thereby heat the contents of the holder of the consumable item;
a power input operably coupled between an external power source and the thermostat and the at least one heating element wherein when the detected temperature is below a predetermined minimum temperature, the power input is configured to energize the at least one heating element and wherein the detected temperature is above a predetermined maximum temperature, the power input is configured to de-energize the at least one heating element;
an indicator assembly operably coupled to the power input to relay to an operator a state of operation of the warming device.

20. The warming device of claim 19, further comprising a heat sink provided between the housing and the container.
